(19) United States
(12) Patent Application Publication
(10) Pub. No.: US 2026/0247183 A1
(43) Pub. Date: Aug. 20, 2026

(54) JITTER MONITORING IN A WIRELESS COMMUNICATION NETWORK

(71) Applicant: InterDigital Patent Holdings, Inc., Wilmington, DE (US)

(72) Inventors: Achref Methenni, Montreal (CA); Rocco Di Girolamo, Laval (CA); Michael Starsinic, Newtown, PA (US); Xavier De Foy, Montreal (CA); Magurawalage Chathura Madhusanka Sarathchandra, London (GB)

(73) Assignee: InterDigital Patent Holdings, Inc., Wilmington, DE (US)

(21) Appl. No.: 19/164,291

(22) PCT Filed: Apr. 5, 2024
(86) PCT No.: PCT/US2024/023446

§ 371 Date: Sep. 11, 2025

Related U.S. Application Data
(60) Provisional application No. 63/457,684, filed on Apr. 6, 2023.

(51) Int. Cl. H04W 24/08; H04L 43/087; H04W 56/00

(52) U.S. Cl. CPC H04W 24/08; H04L 43/087; H04W 56/001

(57) ABSTRACT

Systems, Methods, and instrumentalities are described herein related to jitter monitoring in a wireless communication network. A network device associated with the wireless communication network may receive information regarding one or more aspects of jitter monitoring within the wireless communication network. The network, device may determine a jitter monitoring policy based on the received information, and send the jitter monitoring policy to another device in the wireless communication network. After sending the jitter monitoring policy to the other device in the wireless communication network, the network device may receive an indication of a jitter measurement result from the other device.

### CROSS-REFERENCE TO RELATED APPLICATIONS

This application claims the benefit of Provisional U.S. Patent Application No. 63/457,684, filed Apr. 6, 2023, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE). Wireless communication traffic may be transmitted in one or more protocol data units (PDUs). Due to the nature of the network that carries PDUs (e.g., from an application server (AS) to a network device), the PDUs may experience different delays and the difference in the delays experienced by the PDUs may be measured by jitter.

### SUMMARY

Systems, methods, and instrumentalities are described herein related to jitter monitoring in a wireless communication network. A network device associated with the wireless communication network may receive information regarding one or more aspects of jitter monitoring within the wireless communication network. The network device may determine a jitter monitoring policy based on the received information, and send the jitter monitoring policy to another device in the wireless communication network. After sending the jitter monitoring policy to the other device in the wireless communication network, the network device may receive an indication of a jitter measurement result from the other device.

In examples, the network device may receive the information regarding the one or more aspects of jittering monitoring within the wireless communication network from a network exposure function (NEF) associated with an application server (AS) or an application function (AF). In examples, the network device may transmit the indication of the jitter measurement result to the NEF.

In examples, the information regarding the one or more aspects of jitter monitoring within the wireless communication network may indicate that jitter monitoring is to be performed at a protocol data unit (PDU) set level or a burst level. In examples, the jitter monitoring policy may be associated with a PDU session comprising extended reality traffic.

In examples, the information regarding the one or more aspects of jittering monitoring within the wireless communication network may indicate a jitter measurement time period and/or a jitter sampling time period. In examples, the information regarding the one or more aspects of jittering monitoring within the wireless communication network may indicate a jitter monitoring trigger condition. In examples, the network device may be configured to determine and send the jitter monitoring policy as a quality of service monitoring rule.

In examples, the information regarding the one or more aspects of jitter monitoring within the wireless communication network may be received via a policy authorization request, and wherein the network device may be further configured to transmit a policy authorization response that confirms use of the information received via the policy authorization request. In examples, the network device may be a policy control function of the wireless communication network, and the other device may be a session management function of the wireless communication network.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of configuring connected mode discontinuous reception (CDRX) based on jitter information.

FIG. 3 is a diagram illustrating an example of having more than one service data flow (SDF) for a QoS flow.

FIG. 4 is a diagram illustrating example approaches for performing jitter measurements at a PDU set level.

FIG. 5 is a diagram illustrating an example of a procedure for configuring a jitter monitoring (or jitter measuring) requirement for an XRM service.

FIG. 6 is a diagram illustrating an example procedure for provisioning jitter monitoring, jitter measurement, and/or jitter reporting for a WTRU with tethered devices.

FIG. 7 is a diagram illustrating an example of a PDU set level playout delay buffer.

FIG. 8 is a diagram illustrating an example procedure for jitter monitoring and reduction based on PDU set playout buffers and/or PDU set importance values.

FIG. 9 is a diagram illustrating an example procedure for a radio access network (RAN) to configure CDRX for multiple SDFs over a QoS flow.

FIG. 10 is a diagram illustrating an example of determining a downlink (DL) periodicity and/or a relative time difference associated with multiple SDFs.

FIG. 11 is a diagram illustrating an example of determining a DRX cycle based on multiple SDFs with the same periodicity.

FIG. 12 is a diagram illustrating an example of determining a DRX cycle based on multiple SDFs with different periodicities.

### DETAILED DESCRIPTION

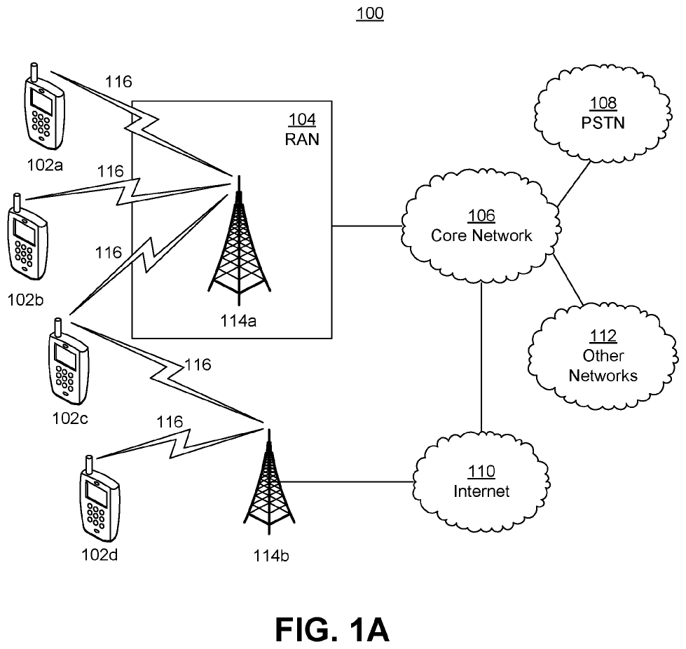

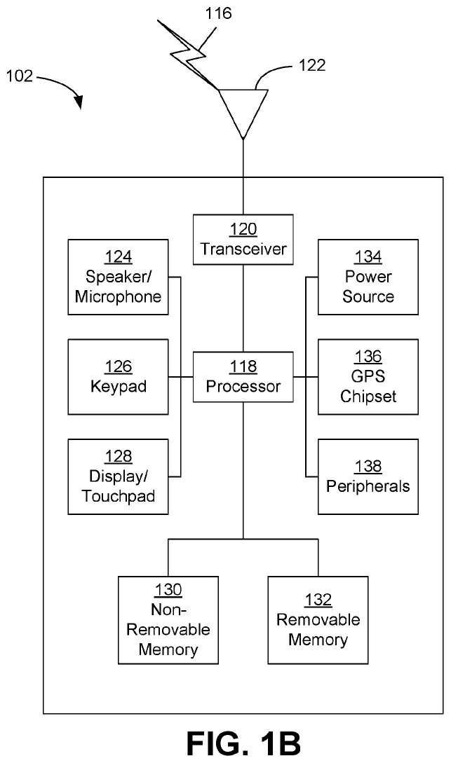

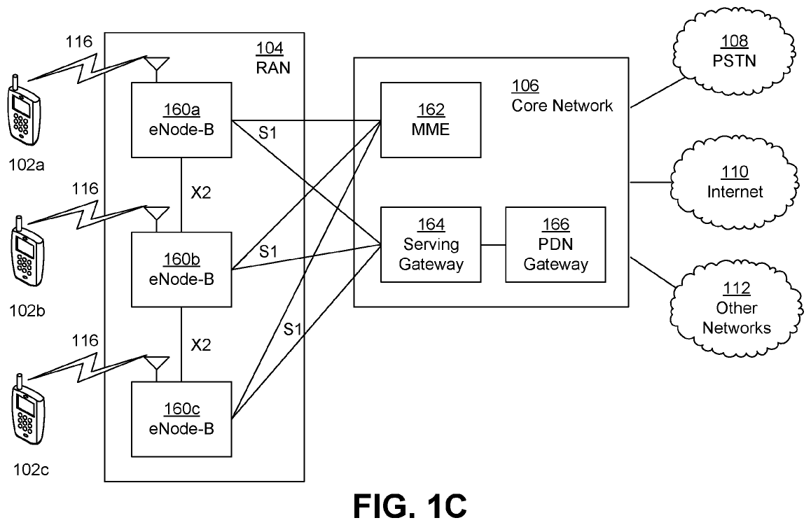

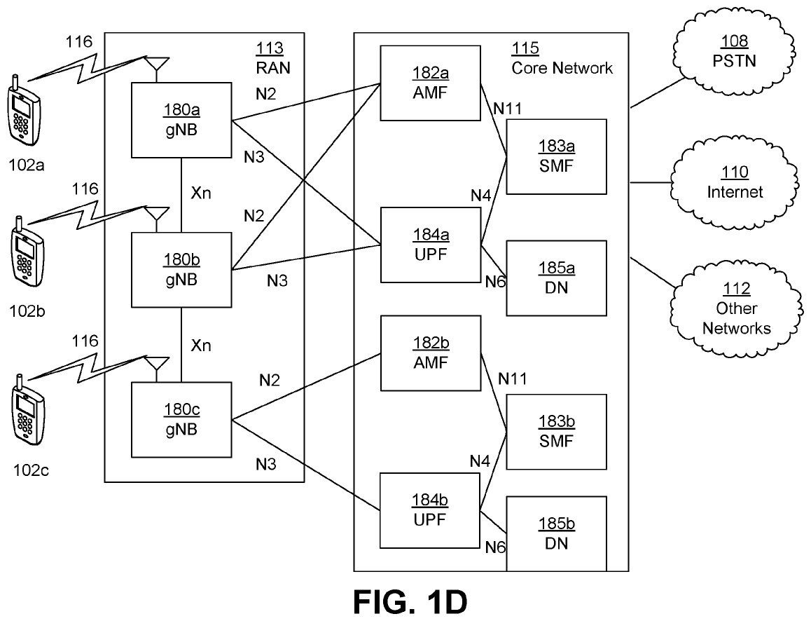

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 1600, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 1600 may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 1800, though it will be appreciated that the RAN 113 may include any number of gNBs while remaining consistent with an embodiment. The gNBs 180a, 180b, 1800 may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 1800 may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 1800 may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 1800 may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WIFI.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to jitter monitoring. The systems, methods, and instrumentalities may be associated with extended and/or multimodal reality (XRM) services. The term “jitter monitoring” may be used interchangeably herein with the term “jitter measuring.”

A network device or node such as a policy control function (PCF) may be configured with (e.g., additional) information regarding jitter monitoring or jitter measurement (e.g., by a WTRU and/or a user plane function (UPF), for example, at a protocol data unit (PDU) set level or a burst level. When referred to herein, a burst may refer to a set of PDUs or one or more PDU sets generated and sent (e.g., by an application) within a period of time. The (e.g., additional) information configured for the network device may include or indicate one or more of the following: information about whether the jitter monitoring should be performed at a PDU level, a PDU set level, or a burst level; information about whether the jitter monitoring is related to a (e.g., each) media modality (e.g., video, audio, tactile, etc.); and/or an indication of what method should be used to calculate a jitter or what type of jitters should be measured, among other parameters. The PCF may generate a jitter monitoring policy (e.g., one or more policy charging and control (PCC) rules that include jitter monitoring information) based on the received information. The PCF may provide (e.g., forward) the jitter monitoring policy (e.g., the one or more PCC rules) to one or more other network devices such as a session management function (SMF), a UPF, and/or a WTRU. The PCF may receive jitter measurement results subsequent to the provision of the jitter monitoring policy. The PCF may notify an application server (AS) or application function (AF) about jitter related events (e.g., the jitter monitoring results), for example, via a network exposure function (NEF) that exposes the PCF and/or other network devices to the AS/AF.

A WTRU and/or a UPF may use a PDU set level playout or de-jittering buffer, e.g., to minimize jittering. The WTRU and/or the UPF may receive configuration information about one or more characteristics of the buffer (e.g., a buffer size). The WTRU and/or the UPF may receive jitter monitoring parameters via one or more QoS rule(s) (e.g., for the WTRU) and/or one or more N4 rules (e.g., for the UPF). The WTRU and/or the UPF may perform jitter measurements. The WTRU and/or the UPF may report results of the measurements to an SMF and/or a PCF. The PCF may send jitter measurement results to an AF/AS (e.g., via aN NEF). The AF/AS may provide information to help modify the PDU set level de-jitter buffer at the WTRU and/or the UPF.

Systems, methods, and instrumentalities are described herein related to jitter monitoring for extended and/or multimodal reality (XRM) services. Systems, methods, and instrumentalities are described herein related to the provisioning of jitter monitoring policies and/or requirements (e.g., at a PDU set level) in a wireless communication network (e.g., such as a fifth-generation system (5GS).

A network device (e.g., a device comprising or configured to perform a policy control function (PCF) may be configured to perform one or more of the following actions. The network device (e.g., the PCF) may receive a message that includes jitter monitoring information. The message may include an indication of whether jitter monitoring is enabled (e.g., required) and/or whether jitter monitoring should be performed at a PDU level, a PDU set level, or a burst level (e.g., for a media modality). The message may include an indication of what method may be used to calculate jitters and/or what type of jitters may be measured. An application function (AF) may foresee (e.g., for some modalities, such as a video modality) different codec settings that a modality (e.g., a video modality) may take, e.g., for an extended and/or multimodal reality (XRM) service. The AF may provide (e.g., indicate to a network device) different jitter monitoring parameters for different combinations of video resolutions and/or frame rates. The AF may provide triggering conditions for jitter monitoring (e.g., for certain modalities). The AF may provide a delay budget, a PDU set delay budget, and/or delay budget monitoring for a (e.g., each) modality. The AF may provide a delay difference threshold between different modalities of an XRM service. The AF may provide jitter monitoring parameters for burst level monitoring.

A network device such as a PCF may use the information provided by an AF/AS (e.g., via a NEF) to determine or generate one or more jitter monitoring policies for a multi-modal service (e.g., extended reality (XR) service). The one or more policies may be determined or generated as part of a quality of service (QoS) monitoring rule (e.g., in the form of one or more policy charging and control (PCC) rules). The network device may send the policies and/or rules to one or more other network devices including, for example, a device comprising or configured to perform a session management function (SMF).

The network device (e.g., PCF) may receive (e.g., from an SMF) a notification about a jitter measurement result, for example, if the amount of measured jitter has exceeded a certain threshold. The network device may send an indication of the jitter measurement result (e.g., a notification related to the jitter measurement result) to the AF, e.g., via an NEF.

A device (e.g., a WTRU and/or a network device/node configured as a UPF) may perform one or more of the following actions. The device may receive jitter monitoring information included in one or more QoS rules provided by a PCF (e.g., via an SMF). The device may perform jitter measurements according to the received jittering monitoring information (e.g., which may include one or more jitter measurement parameters). The device may send a jitter measurement result to the SMF, which may forward the result to the PCF.

A device as described herein may include a processor configured to perform one or more actions configured for the device. For example, a device (e.g., a NEF) as described herein may include a processor configured to receive, from a requesting entity (e.g., an AS/AF), a request for a multi-modal session with a WTRU and/or jitter monitoring information. The device may send a policy authorization request to another device (e.g., to a PCF) for the multi-modal session and/or jitter monitoring associated with the multi-modal session. The device may receive a policy authorization response (e.g., from the PCF), wherein the policy authorization response may confirm authorization of the policy authorization request. The device may send, to the requesting entity (e.g., the AS/AF), a message to confirm the multi-modal session. The device may receive at least one of a jitter measurement result or a notification related to the jitter measurement result (e.g., from the PCF) and may the jitter measurement result or the notification related to the jitter measurement result to the requesting entity.

The jitter monitoring information described herein may indicate whether jitter monitoring should be performed, a jitter calculation type or a jitter calculation method, an index to a set of jitter monitoring parameters, etc. The set of jitter monitoring parameters may comprise a respective jitter monitoring parameter associated with a condition. A message that confirms the multi-modal session may indicate a confirmation of the information and/or parameter(s) indicated by the requesting entity when requesting the multi-modal session and providing the jitter monitoring information. The requesting entity may be an application function.

Traffic in a flow may be periodic. For example, a downlink flow from a server (e.g., an application server) to a WTRU may carry PDUs and the PDUs may be transmitted (e.g., by the server to the WTRU) in a periodic pattern. The periodic pattern may be, for example, one PDU sent every time period.

The delay that each PDU experiences may be different, for example, due to the nature of the network that carries downlink data (e.g., from an AS to a UPF or a WTRU). Jitter may be a measure of how much the delay that is experienced by each PDU varies. Jitter may be a measure of how much the time period used to transmit each PDU varies (e.g., as measured by the UPF).

An application server associated with a wireless communication network or system may provide a network device (e.g., a PCF) with the expected periodicity of a traffic flow. The network device (e.g., the PCF) may provide the expected periodicity of the traffic flow to another network device such as an SMF. The SMF may provide the information to yet another network device such as a UPF.

The UPF may report jitter measurements to the SMF. The SMF may provide the jitter measurements to a RAN node such as a base station. The RAN node may use the information to adjust the connected mode discontinuous reception (CDRX) settings of a WTRU.

The UPF may report jitter measurements to the application server. The jitter measurement reports may be sent directly to the application server, or they may be sent indirectly, for example, via the SMF, the PCF, and/or an NEF. The application server may use the jitter measurement information to configure one or more jitter buffers in a server application and/or a WTRU application.

PDU set integrated handling information (PSIHI) may indicate whether one or more (e.g., all) PDUs of a PDU set should be transmitted/received before the PDU set can be used by an application layer (e.g., on a receiver side). PSIHI may be provided to a network device (e.g., a PCF) by the application server. PSIHI (e.g., if enabled) may be applied to (e.g., all) traffic of a PDU set in a QoS flow.

A de-jitter buffer may (e.g., be configured to) remove the effects of jitter from a received stream, for example, by buffering each arriving packet for a short interval before playing out the packets synchronously. A fixed de-jitter buffer may maintain a constant size. An adaptive de-jitter buffer may (e.g., have a capability to dynamically) adjust a size of the buffer to optimize a delay/discard trade-off.

A de-jitter buffer size (JBS) may be defined as the maximum amount of time packets can stay in the buffer. A de-jitter buffer delay (JBD) may be referred to as a de-jitter delay, a holding time, or a play-out delay. A JBD may correspond to the time packets stay in the buffer, which may be less than the de-jitter buffer size. The time of departure of each packet may be determined by reading out the timestamp information provided by a real-time transport protocol (RTP), for example.

Jitter may be used for CDRX configuration. A network device (e.g., a UPF) may be configured with a session reporting rule to assist an RAN node (e.g., a base station) in establishing CDRX configuration parameters for a WTRU. The session reporting rule may be, for example, “Per QoS Flow N6 Jitter Measurement Report.” The rule may include N6 jitter measurement control information that may indicate that the network device (e.g., UPF) should report N6 jitter information associated with a downlink (DL) periodicity for a QoS flow in a downlink direction (e.g., to assist the RAN node in configuring CDRX for the WTRU). An N6 jitter measurement report may be generated by the network device (e.g., the UPF) and sent to another network device (e.g., an SMF). The report may indicate an N6 jitter measurement result for the periodicity of the QoS flow.

At PDU session establishment with a QoS (e.g., by an AS/AF), a network (e.g., a 5G system) may be provided with periodicity information. The periodicity information may be provided by the AF to a first network device (e.g., a PCF) via an NEF, or directly to the first network device, e.g., if/when the AF is trusted. The first network device (e.g., the PCF) may send the periodicity information received from the AF to a second network device (e.g., an SMF). The first network device may include (e.g., within one or more PCC rules) an indication for the second network device to request a third network device (e.g., a UPF) to perform jitter measurements, e.g., in accordance with operator's local policies.

The second network device (e.g., the SMF) may (e.g., upon reception of the PCC rule(s) determine time sensitive communication assistance information (TSCAI) and may forward the TSCAI to a RAN node (e.g., a base station). The second network device (e.g., the SMF) may send an indication of DL periodicity (e.g., the time period between two data bursts) to the third network device (e.g., the UPF), e.g., if the PCC rule(s) include an indication to perform jitter measurements. The second network device may request the third network device to monitor and/or periodically report jitter information associated with the DL periodicity, e.g., using an N4 session modification procedure. The second network device may provide the DL periodicity in the request to the third network device. How the third network device derives the N6 jitter may be implementation dependent. How the third network device derives the DL periodicity when not provided by an AF may also be implementation dependent.

The second network device (e.g., the SMF) may receive jitter measurement results from the third network device (e.g., the UPF), for example, in an N4 session level report. The second network device may include the jitter measurement information, e.g., together with the associated periodicity, in the TSCAI that the second network device may forward to an RAN node (e.g., via an NG application protocol (NGAP) message). The third network device may send the N6 jitter measurement report periodically or if/when (e.g., only if/when) the measured jitter is larger than a threshold. This may prevent frequent updates from the third network device.

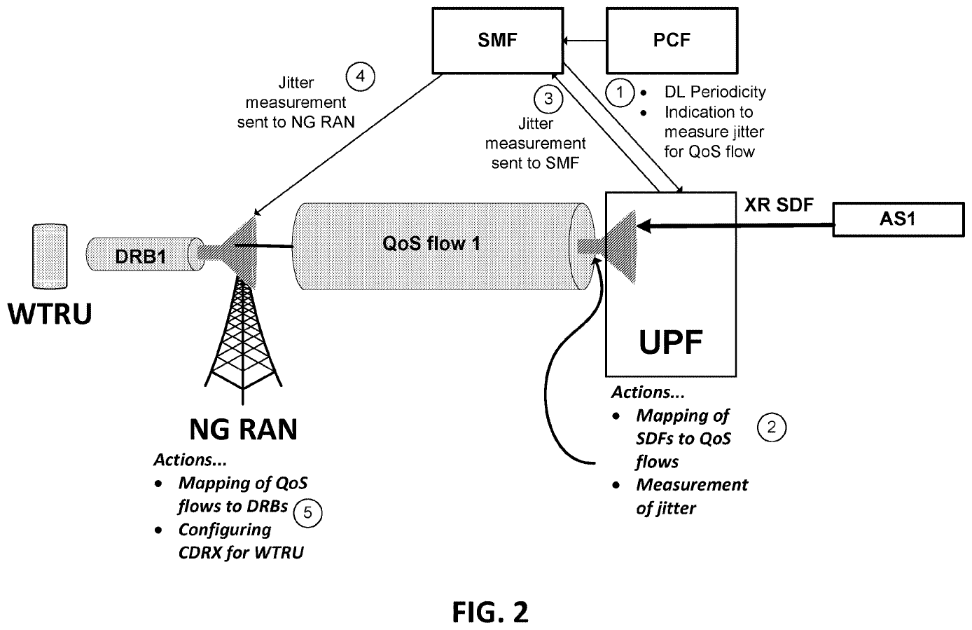

FIG. 2 illustrates an example of jitter measurement/reporting and determination of a CDRX configuration based on jitter information.

As shown in FIG. 2, at 1, a first network device (e.g., a PCF) may send DL periodicity information (e.g., which may be received from an AF/AS) and/or an indication to perform jitter measurements to a second network device (e.g., an SMF), and the second network may forward the received information to a third network device (e.g., a UPF) configured to perform the jitter measurements. In some examples, the second network device (e.g., the SMF) may not receive the DL periodicity information and may request the third network device (e.g., the UPF) to determine the DL periodicity.

At 2, the third network device (e.g., the UPF) may, after receiving jitter measurement related control Information (e.g., N6 jitter measurement control information), perform one or more jitter measurements based on the control information. For example, the third network device may measure and/or report, based on the received control information that may include the jitter monitoring indications and/or rules described herein, N6 jitter information associated with a DL periodicity for a QoS flow in the downlink direction. As part of the process, the third network device may map a service data flow (SDF) to a QoS flow.

At 3, the third network device (e.g., the UPF) may provide jitter measurement information (e.g., a jitter measurement result) to the second network device (e.g., the SMF).

At 4, the second network device (e.g., the SMF) may provide jitter information to a RAN node such as base station.

At 5, the RAN node may use the received jitter information to configure CDRX for a WTRU.

The example shown and described with respect to FIG. 2 may assume that the second network device (e.g., SMF) may provide the DL periodicity information per traffic flow (e.g., per SDF), or that the second network device (e.g., SMF) may ask the third network device (e.g., UPF) to measure the DL periodicity per traffic flow (or per SDF). The example shown and described with respect to FIG. 2 may also assume that one traffic flow (e.g., or SDF) may be mapped to a QoS flow, and/or that jitter may be measured per QoS flow.

A wireless communication network (e.g., a 5G system (5GS) may perform jitter measurements for XRM traffic. A QoS flow associated with one or more PDU sets may be associated with a PDU Set Delay Budget (PSDB). The jitter between PDU sets may be measured and reported, for example, if PDU set based handling is enabled in the communication system. An AF/AS may configure or request jitter monitoring at a PDU set level and/or a burst level, for example, to facilitate PDU set integrated handling. This is because, when PDU set integrated handling is enabled, an application layer may make use of a PDU if (e.g., only if) the (e.g., entire) PDU set has been received. In these situations, jitter between PDUs may be less relevant than jitter between PDU sets.

In some examples, a WTRU may facilitate communication between a device that is tethered to (e.g., attached or associated with) the WTRU and an application server (AS). As described herein, the AS (or AF) may configure or request a network (e.g., a wireless communication network) to measure and report jitter between the AS and the tethered device.

The wireless communication network (e.g., a 5GS) may leverage PDU set handling to help reduce jitter at the application layer so that jitter does not negatively impact user experience. In some examples, a payload playout buffer may be deployed for RTP streams. Some traffic characteristics or specific sets of the traffic may have different jitter requirements. For example, an application may prefer jitter between I frames (e.g., for video contents) to be reduced with a higher priority than jitter between P frames. PDU set handling may be utilized to perform PDU set level buffering, e.g., to minimize jitter, by taking XRM traffic information such as PDU set importance values into consideration.

The wireless communication network (e.g., a 5GS) may help a RAN node such as a base station configure CDRX parameters, for example, if more than one traffic flow (e.g., more than one SDF) is bound to the same QoS flow.

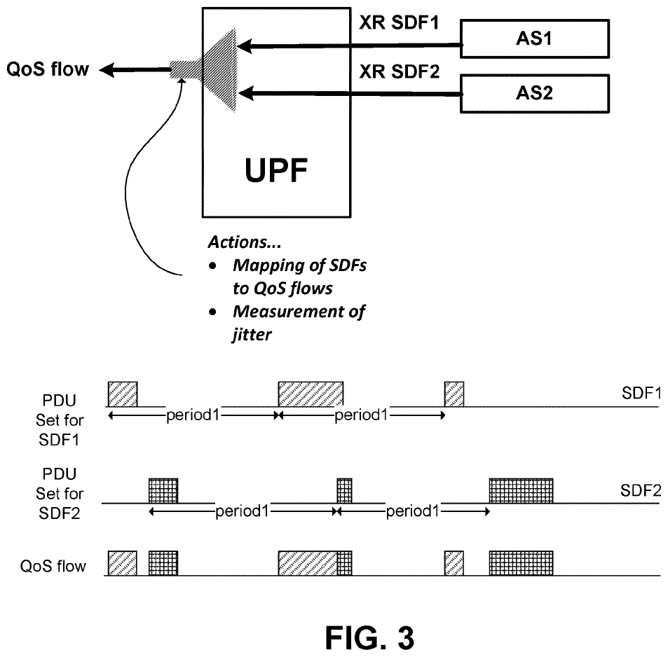

FIG. 3 illustrates an example scenario with more than one SDF per QoS flow. As shown in FIG. 3, DL periodicity may be a property of an SDF and/or the DL traffic arriving at a network device (e.g., a UPF) over the SDF. The network device may receive information that may help the network device calculate the DL periodicity, for example, if the network device is asked to derive the periodicity (e.g., when the DL periodicity is not provided by the AF).

As shown in FIG. 3, jitter may be measured per QoS flow. There may be multiple SDFs multiplexed to a QoS flow, and the SDFs may have different periodicities. The DL transmissions associated with the SDFs may not be time aligned even if the SDFs have the same periodicity. A network may provide support for calculating jitter per QoS flow.

Embodiments of the present disclosure contemplate that jitter monitoring at a PDU set level and/or a burse level may be performed. Jitter between two packets may indicate (e.g., be defined as) the difference (e.g., in absolute value) between the forwarding delay of the two packets (e.g., which may be received consecutively) that may belong to the same stream.

Considering two consecutive PDU sets, the first received PDUs of the PDU sets may be denoted PDU₁ and PDU_{1′}, respectively, and the last received PDUs of each PDU set may be denoted PDU_{N} and PDU_{N′}, respectively. If we denote t_{T1} and t_{R1} as the transmit and receive times of PDU₁, t_{T1′} and t_{R1′} as the transmit and receive times of PDU_{1′}, t_{TN} and t_{RN} as the transmit and receive times of PDU_{N}, t_{TN′} and t_{RN1′} as the transmit and receive time of PDU_{N′}, the jitter J1 between the respective first received PDUs of the two PDU sets may be calculated in accordance with Eq. (1):

$$J 1 = \vert ( {t}_{R 1} - {t}_{T 1} ) - ( {t}_{R {1}^{′}} - {t}_{T {1}^{′}} ) \vert \qquad ( 1 )$$

The jitter J2 between the respective last received PDUs of the two PDU sets may be calculated in accordance with Eq. (2):

$$J 2 = \vert ( {t}_{RN} - {t}_{TN} ) - ( {t}_{{RN}^{′}} - {t}_{{TN}^{′}} ) \vert \qquad ( 2 )$$

In some examples, PDU set jitter may be determined or measured as the average of jitter J1 and jitter J2, for example, in accordance with Eq. (3), which may be referred to herein as a first approach:

$$PDU\_Set \_Jitter = ( J 1 + J 2 ) / 2 \qquad ( 3 )$$

In some examples, PDU set jitter may be determined or measured as the jitter for the respective first received PDUs of the two PDU sets, e.g., PDU_Set_Jitter=J1, which may be referred to herein as a second approach.

In some examples, PDU set jitter may be determined or measured as the jitter for the respective last received PDUs of the two PDU Sets, e.g., PDU_Set_Jitter=J2, which may be referred to herein as a third approach.

A PDU Set Delay (PSD) may indicate (e.g., be defined as) the delay that a PDU set may experience for the transfer between a WTRU and an N6 termination point (e.g., at a UPF). For example, the PSD may be calculated as the time between the reception of the first PDU and the reception of the last PDU of the PDU Set. Using this definition, the PDU set delays for PDU set 1 and PDU set 2 may be determined (e.g., using the previous notations) in accordance with Eq. (4):

$$PSD 1 = \vert {t}_{RN} - {t}_{T 1} \vert and PSD 2 = \vert {t}_{{RN}^{′}} - {t}_{T {1}^{′}} \vert \qquad ( 4 )$$

Jitter related to two PDU Sets may also be measured, for example, based on the difference between PSD measurements, for example, in accordance with Eq. (5), which may be referred to herein as a fourth approach:

$$PS\_Jitter = \vert PSD 1 - PSD 2 \vert \qquad ( 5 )$$

The example approaches described herein may be different and may carry different information about the delay difference regarding PDU sets. One or more of (e.g., all) of the approaches may be relevant to an application function. For example, the jitter measurement using Eq. (3) may indicate how much the jitter per PDU changes on average during the transmission of the PDU set. The jitter measurement using Eq. (5) may indicate how much the PDU set delay varies from one PDU set to the next one, which may be useful, for example, to set the PSDB value for the QoS flow that carries the PDU set.

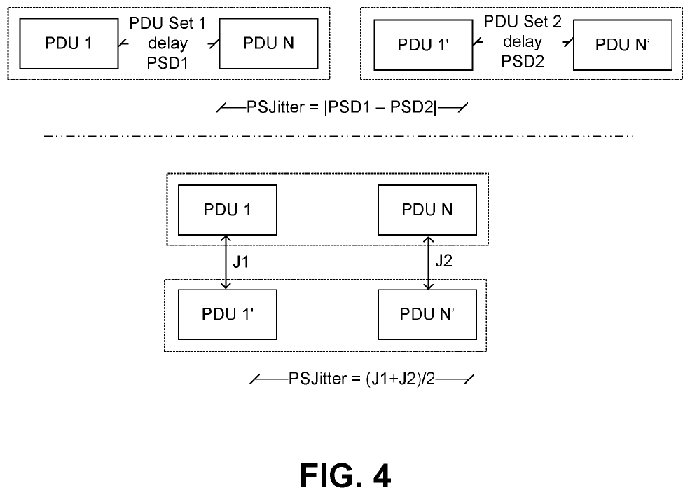

FIG. 4 illustrates example approaches for performing jitter measurement at a PDU set level. Similar approaches for calculating and measuring jitter at a burst level may be used, for example, by considering the respective first and last successfully delivered PDUs of two bursts (e.g., using any of the equations or approaches described herein) to calculate a jitter. The jitter measurement and calculation may use, for example, the first PDU and/or PDU set of the burst, and the last PDU and/or PDU set of the burst.

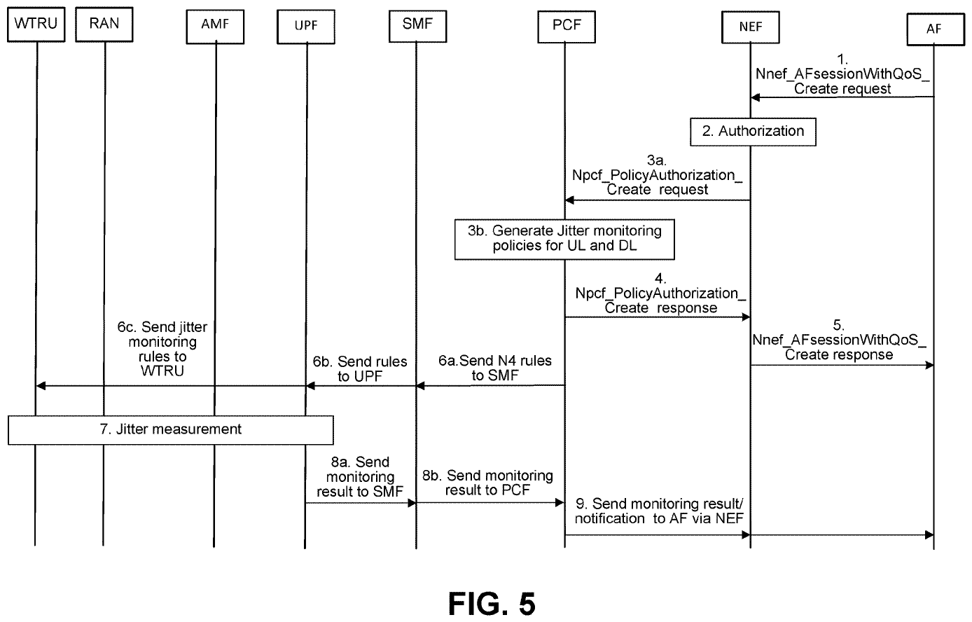

PDU set jitter monitoring requirements may be provisioned in a wireless communication network (e.g., a 5GS). In some examples, an application function (AF) may request to establish a multi-modal XRM session with a WTRU through the wireless communication network (e.g., 5GS). The AF may provide requirements and/or configuration information related to jitter monitoring. FIG. 5 illustrates an example of how the wireless communication network (e.g., 5GS) may be configured with the information to serve a multi-modal service between the AF and the WTRU.

At 1 of FIG. 5, the AF (or an AS) may request to set up a multi-modal session with the WTRU via the wireless communication network (e.g., 5GS), for example, by invoking an NEF application programming interface (API). As an example, the API may be modeled after the Nnef_AFsessionWithQoS service operation. The AF may provide (e.g., in the request) service information, such as flow description information, WTRU address, and/or a combination of data network name (DNN) and single network slice selection assistance information (S-NSSAI). The AF may provide service requirements related to the multi-modal service, for example, including QoS monitoring requirements and/or QoS parameters, such as a packet delay budget for a (e.g., each) media modality.

The AF may provide jitter monitoring information (e.g., jitter monitoring parameters) for the multi-modal service (e.g., which may be an XRM service), The jitter monitoring information/parameters for the XRM service may indicate, for example, one or more of the following: an indication of whether jitter monitoring is required; an indication of whether jitter monitoring should be performed at a PDU level, a PDU set level, or a burst level (e.g., for a media modality); a jitter monitoring period or jitter monitoring frequency (e.g., for downlink traffic and/or for a modality); an indication of what method should be used to calculate the jitter and/or what type of jitter should be measured; CODEC settings associated with a video modality of the XRM service; events/conditions that may trigger the wireless communication network to perform certain operations (e.g., such as reporting jitter measurements and/or jitter monitoring events to the AF); uplink jitter monitoring mode(s) and/or parameters; round trip (RT) related jitter monitoring parameters; conditions to trigger the jitter monitoring for certain modalities; PSIHI enablement and/or indication; jitter monitoring parameters for burst level monitoring; a multi-modal service ID; etc.

The AF may provide an indication of whether jitter monitoring is required and if so, an indication of whether jitter monitoring should be performed at a PDU level, a PDU set level, or a burst level for a (e.g., each) modality. The AF may provide (e.g., for downlink traffic and/or for each modality) a jitter monitoring period and/or jitter monitoring frequency. The AF may provide PDU set jitter monitoring requirements (e.g., frequency, period, etc., for each modality) if PDU set handling is enabled for an XRM service.

The AF may provide an indication of what method should be used to calculate the jitter and/or what type of jitter should be measured. The AF may indicate which method it prefers the wireless communication network to use, for example, if the AF is aware or has a pre-agreement with the wireless communication network about the possible methods to use to calculate jitter (e.g., PDU set jitter).

The AF may provide (e.g., for some modalities, such as video modality) different codec settings that the video modality may be able to take for the XRM service. For example, the AF may provide different jitter monitoring parameters for different video resolutions, frame rate combination, etc. The AF may provide the parameters in advance so that when the wireless communication network is aware that the codec settings changed or are about to change, the wireless communication may change or retrieve the jitter monitoring parameters accordingly. The sets of parameters may be indexed so that if the index of the used codec setting has changed, the wireless communication network knows which jitter monitoring parameters are used.

The AF may specify events that may trigger the wireless communication network to perform certain operations including, for example, to report jitter measurements and/or jitter monitoring events to the AF. For example, the AF may provide threshold values for PDU set jitter, so that if a the PDU set jitter measurement exceeds the threshold, the wireless communication network may report the event to the AF (e.g., the report may additionally indicate jitter measurement results). For example, the AF may provide different thresholds and/or ranges for jitter values (e.g., for each modality), and the wireless communication network may report to the AF which range the jitter belongs to (e.g., or perform a certain action if possible).

The AF may provide an uplink jitter monitoring mode and/or parameters, for example, similar to the downlink (e.g., measurement period, reporting frequency, and/or event notification configuration). The AF may provide round trip (RT) related jitter monitoring parameters. In some scenarios, the AF may be interested in the round-trip jitter measurement information, e.g., instead of DL or UL jitter measurement information.

The AF may specify conditions that may be trigger jitter monitoring for one or more certain modalities. For example, the AF may provide a delay budget (e.g., PDU set delay budget) and/or delay budget monitoring for a (e.g., each) modality. The AF may provide a delay difference threshold between different modalities of the XRM service. The AF may consider it irrelevant to measure the jitter, for example, if the delay measurement is above a (e.g., certain) value. The AF may tell the wireless communication network to stop monitoring jitter for certain modalities, for example, if the delay difference measurement between two modalities is above a (e.g., certain) threshold (e.g., because synchronization is not held between modalities by a threshold amount). Related monitoring versus separate monitoring may not be relevant or may not be needed, for example, if another monitoring is not satisfied.

The AF may provide an indication of whether PDU set integrated handling is enabled and/or a PSIHI indication. When PDU set integrated handling is enabled, some or all of the PDUs of a PDU set may be needed for the PDU set to be useful in an application layer. For example, if all PDUs of a PDU set are needed for the PDU set to be useful, the PDU set may be discarded if one of its PDUs is lost. In some examples, the absence of an indication of PDU set integrated handling enablement may mean that it is possible to lose one or more (e.g., some) PDUs from a PDU set (e.g., not more than a certain percentage of PDUs) without considering that the PDU set is irrelevant and can be discarded (e.g., the PDU set may be kept in this situation). In some examples (e.g., depending on whether a PDU set integrated handling enablement indication is present), the AF may (e.g., impliedly) instruct a wireless communication network to perform jitter monitoring differently (e.g., for each modality). An indication of PDU set integrated handling enablement may impact which PDU sets may be considered for a PDU set jitter measurement, and/or how the jitter may be measured (e.g., for partially recovered PDU sets or fully received PDU sets). The AF may provide one or more parameters indicating the method or approach to use and/or which type of PDU set to use for the jitter monitoring (e.g., for each modality).

The AF may provide jitter monitoring parameters for burst level jitter monitoring. The AF may provide traffic description information for the bursts, which may be in the form of an IP 3-tuple. If, for example, more than one modality is carried within a QoS flow, the AF may provide the same or different burst level jitter measurements for each modality. The AF may, in this case, provide different monitoring parameters for the traffic descriptor of each XRM modality. The AF may specify whether the AF requests intra-burst (e.g., within the burst itself) and/or inter-burst (e.g., between consecutive bursts) jitter measurements. The AF may provide a measurement period, which may be a time duration over which a jitter measurement may be performed. The AF may provide a sampling period, which may represent how often the wireless communication network (e.g., a 5GS) may take a sample PDU/PDU set and use the sample in the calculation of burst level jitter. For example, the AF may indicate that within a measurement period of 20 ms, the wireless communication network should sample a PDU/PDU set every 4 ms and use the sample (e.g., including the transmit and receive times) for jitter measurement.

The AF may provide a number of PDU sets to be used for burst level jitter measurement in a (e.g., certain) period of time. For example, the AF may request to use five (5) PDU sets every 30 ms to measure jitter. The AF (e.g., if possible) may specify which PDU sets to use for a measurement. For example, the AF may indicate that the AF wants the wireless communication network to include the first PDU set as well as the last PDU set in the burst(s) to be used to calculate the jitter. The AF may use traffic characteristics as parameters. For example (e.g., for a video modality), the AF may request to use 75% I frames and 25% non-I frames in the calculation of the burst jitter, and/or the AF may provide a pattern of frames to use to calculate the burst level jitter (e.g., use the pattern IPPPI to calculate the jitter).

The AF may provide a multi-modal service ID, which may an identifier that associates multi-modal flows belonging to the same multi-modal service. The AF may send the multi-modal session setup request and/or the jitter monitoring information (e.g., jitter monitoring parameters) to the NEF at 1 of FIG. 5.

At 2 of FIG. 5, the NEF may authorize the request from the AF.

At 3a of FIG. 5, the NEF may send a policy authorization request to another network device such as a PCF. The NEF may send to the PCF (e.g., in the policy authorization request or a separate message) the information that was provided to the NEF at 1. The information may include, for example, traffic flow descriptors, a WTRU address, and/or a multi-modal service ID. The information may include PDU set and/or other jitter monitoring parameters.

At 3b of FIG. 5, the PCF may authorize the request from the NEF. The PCF may generate jitter monitoring policies for the relevant multi-modal XRM service based on the request. The policies may be part of a QoS monitoring rule (e.g., which may be included in one or more PCC rules), for example, if other parameters, such as PDU set delay, are requested to be monitored by the AF for the XRM service. The PCF may associate multiple (e.g., two) QoS monitoring rules with a common identifier.

At 4 of FIG. 5, the PCF may send a policy authorization response message to the NEF, for example, to confirm the authorization of the service request.

At 5 of FIG. 5, the NEF may send a message to the AF, for example, to confirm the provisioning of the XRM service with the parameters and information provided by the AF at 1.

At 6a and 6b of FIG. 5, the PCF may send information regarding jitter monitoring (e.g., the jittering monitoring policy determined by the PCF) to another network device such as the SMF, and the SMF may forward the jitter monitoring policy to yet another network device such as the UPF. This information (e.g., policy) provided at 6a and 6b may include or reflect the information provided at 1, and the UPF may use the information (e.g., a measurement period and/or a sampling period) to set up a jitter measurement procedure (e.g., with the corresponding periods and appropriate timers). For example, the UPF may use the information to determine the granularity of jitter monitoring/measurement to be performed (e.g., for each modality), such as whether the jitter monitoring/measurement should be performed per PDU, per PDU set, or per burst, whether the jitter monitoring/measurement is for the uplink and/or the downlink, and/or which method to use for the jitter monitoring/measurement.

The UPF may use the information to set up triggers and conditions for sending a notification about jitter measurement (e.g., a measurement report) to the SMF. For example, the triggers and conditions may include a reporting frequency. As another example, the triggers and conditions may include a threshold value for sending the notification to the SMF (e.g., the notification may be sent if measured jitter exceeds the threshold value).

As described herein, PDU set handling may be enabled in a wireless communication network (e.g., a 5GS) for a PDU session that carries XRM traffic. Per PDU set or burst level jitter monitoring may be requested, and the UPF may use PDU sequence numbers, PDU set sequence numbers, and/or an end of burst indication to determine which PDUs or PDU sets to use for jitter measurement (e.g., to add timestamps to). Some of this information may be available to the UPF in a header (e.g., a GTP-U header) of the PDUs of the PDU set.

The UPF may use (e.g., if available) PDU set importance information to determine if a certain PDU set is to be considered for a jitter calculation. The UPF may use the PDU set importance value to differentiate between I frames and P frames (e.g., for the video modality), for example, if a pattern for jitter measurement (e.g., for burst level jitter monitoring) was provided and/or if a percentage of I frames to be used for jitter measurement (e.g., for burst level jitter monitoring) was provided.

At 60 of FIG. 5, the jitter monitoring policy described herein (e.g., including jitter monitoring parameters) may be sent to a WTRU. The jitter monitoring policy may be sent to the WTRU, for example, by the SMF, which may send rules related to jitter monitoring to the WTRU as part of a QoS rule. As another example, the jitter monitoring policy may be provided to the WTRU by the PCF (e.g., via a WTRU configuration update procedure).

At 7 of FIG. 5, the WTRU and/or the UPF may perform jitter measurement (e.g., for DL and/or UL traffic), e.g., using one or more of the jitter calculation techniques described herein.

At 8a and 8b of FIG. 5, the UPF and/or the WTRU may send an indication of the jitter measurement results to a network device such as the SMF.

At 9 of FIG. 5, the PCF may send the jitter measurement result or a notification related to the jitter management result to the AF (e.g., via the NEF). The AF (or AS) may leverage the jitter management result. For example, the AF may adjust the parameters of jitter buffers at an application level. For example, the AF may decide to reduce the size of the jitter buffers for a modality, such as a modality where the jitter is considerably low. The AF may decide to increase the PDU set delay budget (PSDB) for a modality, for example, if the AF received an indication that the PDU set level jitter for the modality exceeded a provided threshold. An increase in the PSDB for a modality may permit the application server to take into account the jitter larger than threshold variation, which may help with PDU set based QoS handling at the RAN.

The AF may use the jitter between the WTRU and the UPF together with N6 jitter (e.g., between the AS and the UPF) that the AF may already know to assess the overall jitter. The AF may decide to adjust its buffers based on the assessment of the overall jitter.

The AF may decide to change a frame rate for a video modality based on the jitter measurement result. For example, for videos provided at 120 fps, if the AS determines that the PDU set level jitter is high (e.g., exceeds a threshold), the AS may switch to a 90 fps configuration so that the jitter may decrease and have less effect on the video modality.

PDU set related jitter monitoring requirements may be provided for devices tethered (e.g., attached) to a WTRU. In an example, a WTRU that is exchanging traffic with an AF/AS for an XRM service may be tethered to other devices (e.g., AR glasses and/or haptic gloves), and may receive XRM traffic associated with those devices. In this scenario, the AF and a wireless communication network may configure jitter measurement/reporting between the WTRU and a network device (e.g., the UPF) for a tethered link for each modality.

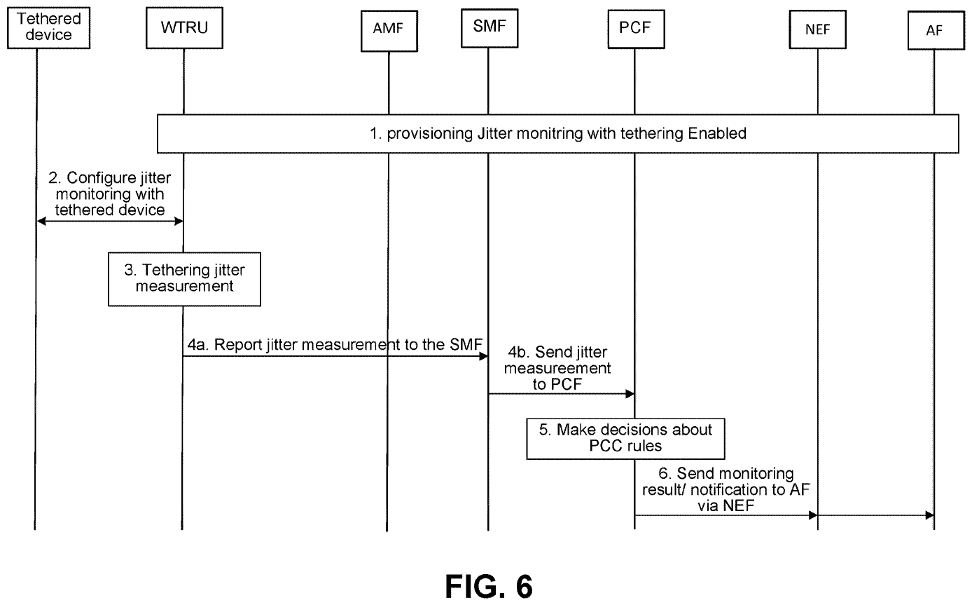

FIG. 6 illustrates an example of a procedure for provisioning jitter monitoring, jitter measurement, and/or reporting for a WTRU with tethered devices.

As shown in FIG. 6, at 1, with tethering enabled, an AF may request to set up a multi-modal session (e.g., for XMR services) with a WTRU via a wireless communication network (e.g., a 5GS). The AF may do so, for example, by invoking an NEF API. The AF may provide jitter monitoring parameters for the tethered link. The AF may provide end-to-end jitter monitoring requirements. Based on the information provided by the AF, the wireless communication network may derive one or more jitter monitoring rules or requirements for one or more communication links or legs including, for example, a UPF-to-WTRU leg and/or a tethered leg. The jitter monitoring requirements may include a tethered device requirement. Based on the requirements, the WTRU may monitor a tethering transmission delay between the WTRU and the tethered device. The WTRU may report the monitored tethering transmission delay to the AF.

In the example shown in FIG. 6, a PCF may authorize a jitter monitoring request (e.g., from the AF) and generate one or more jitter monitoring policies for the multi-modal session (e.g., related to the XRM services). The jitter monitoring policies may include WTRU-to-UPF jitter monitoring parameters and/or tethering jitter monitoring parameters. The PCF may send the policies to an SMF, which may forward them to a UPF and the WTRU.

At 2 of FIG. 6, the WTRU may configure jitter monitoring with the tethered device.

At 3 of FIG. 6, the WTRU may perform jitter measurement for the tethered link.

At 4a of FIG. 6, the WTRU may send the jitter measurement results to the SMF. In examples, the measurement results sent to the SMF may not indicate a request for a delay budget, but may indicate a measurement or an estimate of the transmission delay between the WTRU and the tethered device. Such an estimate may be based on a pre-configuration. For example, the WTRU may be configured to report transmission delays for devices that are connected to the WTRU via Bluetooth. The WTRU may be configured to calculate the delays based on a formula. The inputs to the formula may be, for example, the RAT type that is used to connect to the WTRU and the distance between the WTRU and the tethered device. In the measurement results sent to the SMF, the WTRU may include an IP 4-tuple that the measurement results may be associated with.

At 4b of FIG. 6, the SMF may report a tethering measurement result to the PCF, based on the measurement results provided by the WTRU.

At 5 of FIG. 6, the PCF may use the information reported by the SMF to make or change PCC rules. For example, the PCF may know from the reported information that significant jitter may come from the tethered link, and the PCF may send a notification (e.g., regarding PCC rule changes and/or QoS parameter changes) to the AF so that one or more application layer configurations may be adjusted (e.g., by the AF) to reduce the jitter (e.g., the PCF may not be able to solve the jitter problem on its own).

At 6 of FIG. 6, the PCF may send the jitter measurement results and/or a notification related to the jitter measurement results to the AF (e.g., via the NEF). For example, if the PCF knows that significant jitter comes from the tethered link, the PCF may indicate to the AF that the jitter may not be improved any further.

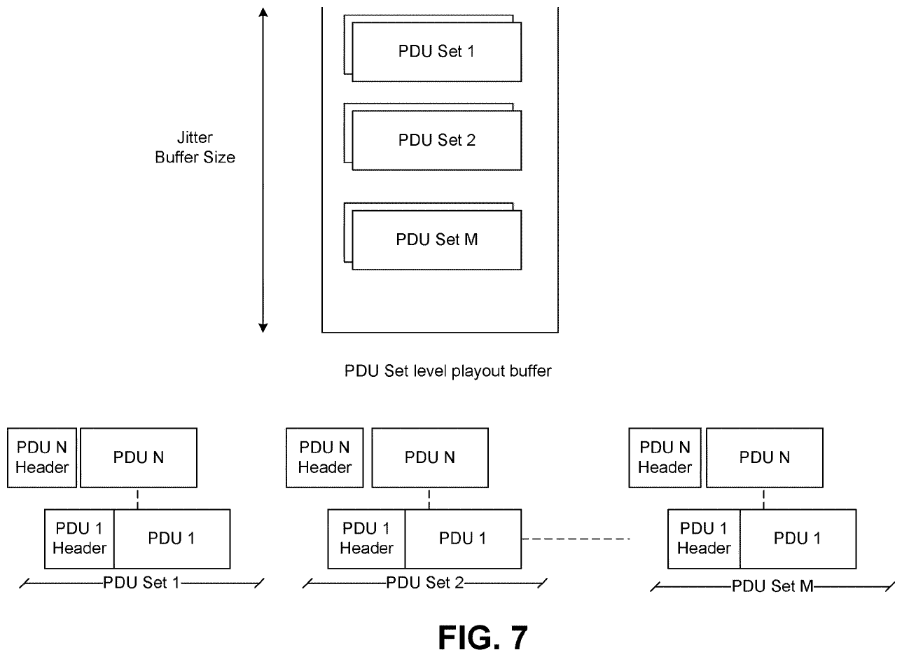

A PDU set level payload playout buffer may be implemented at a WTRU and/or a UPF. A PDU set level playout delay buffer may be implemented at a WTRU and/or a UPF. The buffers may be configured, used, and/or managed at a PDU set level (e.g., consider PDU set information when storing and/or releasing data to reduce jitter associated with a PDU set). FIG. 7 illustrates an example of a PDU set level playout delay buffer. The buffer may be similar to a payload playout buffer used at an application layer to reduce jitter associated with a stream of data (e.g., comprising RTP packets). The buffer may be used to reduce jitter in a wireless communication network. A WTRU may be configured with PDU set handling functionalities to reduce jitter associated with downlink traffic at the PDU set level, A network device such as a UPF may be configured with PDU set handling functionalities to reduce jitter associated with uplink traffic at the PDU set level. These functionalities may utilize the PDU set level playout buffer or the PDU set level playout delay buffer for PDU sets. The buffer may be used to handle packets at a PDU set level. The buffer may be characterized by a jitter buffer size and/or a buffer delay. These parameters may be different and may change for various scenarios and implementations.

The treatment of PDU sets with the playout buffer may depend on the type of the PDU sets, the modality associated with the PDU sets, sizes of the PDU sets, and/or respective importance of the PDU sets. For example, PDU sets with certain importance values (e.g., I frames) may be prioritized over PDU sets with other importance values.

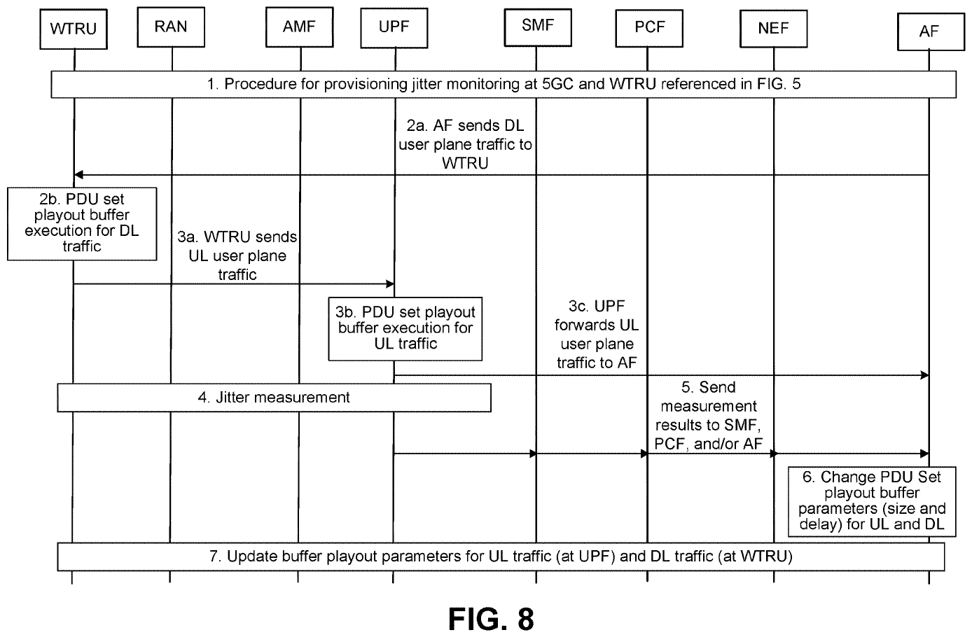

Jitter monitoring and reduction (e.g., for XRM services) may be performed based on the importance of PDU sets. FIG. 8 illustrates an example of a procedure for jitter monitoring and minimization based on PDU set playout buffers and/or PDU set importance.

As shown in FIG. 8, at 1, the procedure shown in FIG. 5 (e.g., steps 1 to 6c) regarding provisioning jitter monitoring information to a wireless communication network (e.g., a 5GS) and/or a WTRU may be performed. In addition to jitter monitoring related parameters described in association with the procedure shown in FIG. 5, an AF may provide additional and/or alternative parameters. For example, the AF may provide periodicity information to the wireless communication network to facilitate the configuration of jitter measurement per PDU set importance value. The AF may provide different jitter monitoring parameters depending on the PDU set importance value. The AF may provide the importance level (e.g., a threshold importance level) of a PDU set for which a jitter measurement should be performed. For example, for a video modality, the AF may be interested to know the jitter related to I frames, so the AF may provide an importance level or indication to indicate that jitter for PDU sets associated with I frames should be measured. The AF may provide multiple PDU set importance values for which jitter monitoring should be performed (e.g., I frame vs B frame for a video modality). The AF may provide information that helps configure PDU set playout delay buffer parameters, such as buffer sizes and/or buffer delay sizes. At 2a of FIG. 8, user plane XRM DL traffic may be sent form the AF to A WTRU.

At 2b of FIG. 8, PDU set traffic arriving at the WTRU may pass through a PDU set level playout delay buffer to reduce jitter (e.g., before the traffic is sent to an application layer).

At 3a of FIG. 8, the WTRU may exchange UL traffic with a network device such as a UPF.

At 3b of FIG. 8, UL PDU set traffic arriving at the UPF may be passed through a PDU set playout buffer to reduce jitter.

At 3c of FIG. 8, the UPF may forward the UL traffic to the AF.

At 4 of FIG. 8, the WTRU and/or the UPF may perform jitter measurement, e.g., using one or more of the jitter determination techniques described herein.

At 5 of FIG. 8, the wireless communication network (e.g., WTRU, UPF, and PCF) may send a jitter measurement result and/or corresponding event notifications to the AF (e.g., via the NEF).

At 6 of FIG. 8, the AF may, according to the received jitter measurement results and/or notifications, decide to change PDU set playout delay buffer parameters, such as a buffer size and/or a buffer delay size.

At 7 of FIG. 8, the AF may provide the changes to the wireless communication network, for example, using the procedure shown in FIG. 5 Error! Reference source not found.

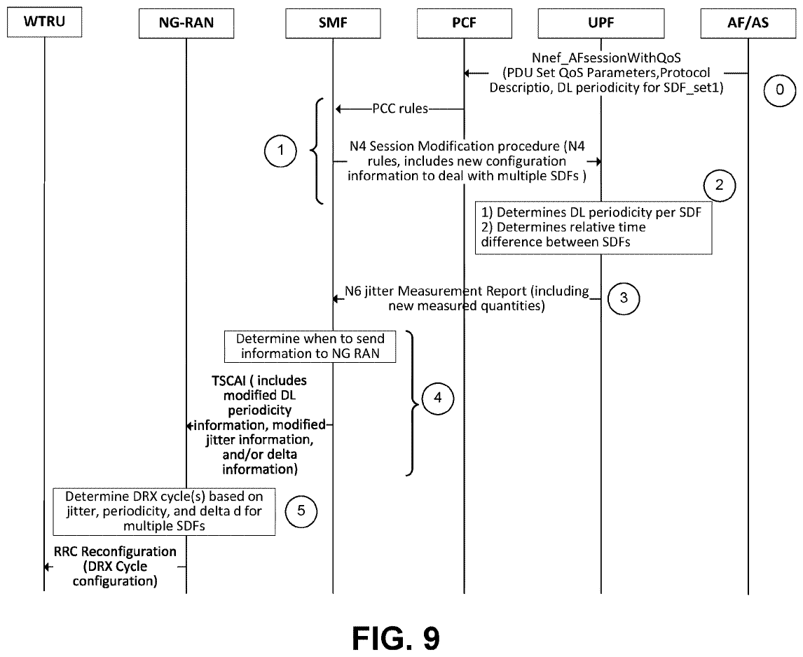

CDRX may be configured for a QoS flow that may be associated with multiple SDFs. A WTRU may be interested in receiving multiple traffic flows (e.g., or SDFs) such as XR traffic flows. A (e.g., each) traffic flow may be associated with a set of QoS requirements and/or QoS characteristics. Traffic for the traffic flows may be split into PDU sets. The mapping of traffic flows (e.g., XR traffic flows) to QoS flows may be based on the QoS parameters of the XR flows. The QoS flow may represent the finest granularity of QoS differentiation in a PDU session. It may be expected that a QoS flow may (e.g., only) multiplex traffic that has similar QoS requirements and/or characteristics. The AF may provide PDU set related assistance information for dynamic PCC control. FIG. 9 shows an example procedure (e.g., for a RAN node such as a base station) to configure CDRX for a WTRU interested in receiving multiple traffic flows (e.g., multiple SDFs) such as multiple XR traffic flows associated with a QoS flow.

As shown in FIG. 9, at 0, an AF may provide the DL periodicity for a subset of SDFs (e.g., SDF_set1). As a result, the DL periodicity may be known for SDF_set1 and unknown for other SDFs (e.g., SDF_set2). One or more of the following PDU set related assistance information may be provided to an NEF and/or a PCF, for example, using an AF session with a certain QoS procedure: PDU set QoS parameters and/or a protocol description that may indicate the protocol and/or payload type used by an SDF.

The PDU set QoS parameters and/or the protocol description (e.g., provided by the AF) may be used by the PCF to determine a QoS profile and/or by a PDU session anchor (PSA) UPF to identify PDU set information. The PDU set Information may comprise, for example, one or more of the following; a PDU set sequence number; an indication of an end PDU of the PDU set; a PDU sequence number within the PDU set; and/or a PDU set importance value, which may indicate the relative importance of the PDU set compared to other PDU sets within the QoS flow.

At 1 of FIG. 9, the PCF may provide one or more policy rules to the UPF, e.g., via the SMF. The policy rules may include PDU set QoS parameters, a protocol description, and/or N6 jitter measurement control information, which may indicate to the UPF to report N6 jitter information associated with a DL periodicity for a (e.g., one) QoS flow in the downlink direction. Additional information that may be provided to UPF includes, for example, one or more of the following: a list of SDFs for which DL periodicity is provided (e.g., SDF_set1); a list of SDFs for which the UPF may determine DL periodicity for an SDF (e.g., SDF_set2); a list of SDFs for which the UPF may determine jitter of an SDF (e.g., SDF_set3); an indication of which SDF may be the primary SDF; a reporting periodicity; reporting thresholds; and/or a jitter calculation configuration.

The PCF may provide a list of SDFs for which DL periodicity is provided (e.g., SDF_set1). For example, for each SDF in SDF_set1, the DL periodicity may be provided. The PCF may provide a list of SDFs for which the UPF may determine DL periodicity for an SDF (e.g., SDF_set2). For example, for each SDF in SDF_set2, an indication may be provided about whether the UPF should report the determined DL periodicity to the SMF. The PCF may provide a list of SDFs for which the UPF may determine jitter of an SDF (e.g., SDF_set3). For example, for each SDF in SDF_set3, an indication may be provided about whether the UPF should report determined jitter to the SMF. The PCF may provide an indication of which SDF may be the primary SDF. A relative time difference (e.g., delta) calculated for the wireless communication network (e.g., a 5G system) may be with respect to the primary SDF.

The PCF may provide a reporting periodicity, e.g., a time between N6 jitter measurement reports from the UPF to the SMF. The periodicity may be common for multiple (e.g., all) SDFs, or common to a group of SDFs. For example, (e.g., all) SDFs with the same DL periodicity may be configured with the same reporting periodicity. The UPF may be configured with multiple thresholds. For example, periodicities may be related to a change in jitter measurements, a change in a measured DL periodicity, or a change in a relative time difference (e.g., delta) between a SDF and the primary SDF.

The PCF may provide one or more reporting thresholds. For example, an N6 jitter measurement report to the SMF may be sent when the measured jitter exceeds a configured threshold. The configured thresholds may be common for multiple (e.g., all) SDFs or to a group of one or more SDFs. For example, (e.g., all) SDFs with the same DL periodicity may be configured with the same threshold. The UPF may be configured with multiple thresholds. For example, the thresholds may be related to a change in jitter measurements, a change in a measured DL periodicity, or a change in a relative time difference (delta) between a SDF and the primary SDF.

The PCF may provide a jitter calculation configuration, which may include configuration information regarding which metric to measure. For example, the metric may be a mean, a variance, a standard deviation, a median, or K-th percentiles. The jitter calculation configuration may indicate an observation window, e.g., the time over which the metric is obtained. The jitter calculation configuration may indicate an observation sample size, e.g., the minimum number of jitter measurements that may be performed to determine the metric.

At 2 of FIG. 9, the UPF may determine the periodicity for the SDFs in SDF_set2. The UPF may also measure the jitter for the SDFs in SDF_set3. The UPF may make the measurements according to the jitter calculation configuration. The UPF may rely on the PDU set QoS parameters and/or the protocol description to identify the SDFs and/or the PDU sets within an SDF. The UPF may determine the relative time difference (e.g., delta) between the DL traffic arriving on a (e.g., each) SDF and the primary SDF.

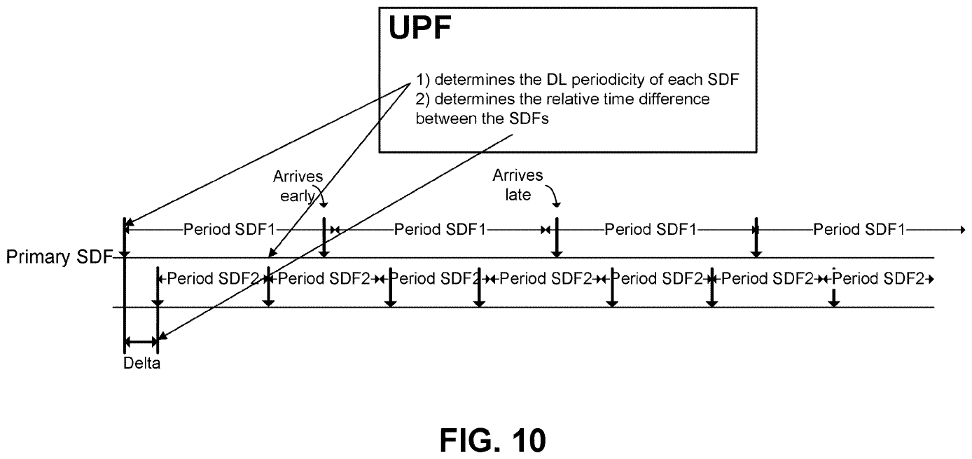

FIG. 10 shows examples of a first SDF (e.g., SDF 1, which may be a primary SDF), a second SDF (e.g., SDF2), and a determination of a DL periodicity and/or a relative time difference associated with SDFs. The SDFs may have different periodicities. The periodicities may be known to the UPF, e.g., based on configuration from the SMF and/or based on internal measurements. As shown in FIG. 10, in some cases, the PDU sets on an (e.g., each) SDF may arrive earlier than expected, while in other cases the PDU sets on the SDF may arrive later than expected. The UPF may find the relative time difference between SDF2 and SDF1 (e.g., the primary SDF), which may suggest that an SDF2 PDU set arrives delta msec after an SDF1 PDU set. The UPF may know when the PDU sets are expected at the UPF, for example, based on knowledge about the periodicities of the two SDFs and the calculated delta.

Reverting to FIG. 9, at 3, the UPF may provide a jitter measurement report such as an N6 jitter measurement report to the SMF. The jitter measurement report provided by the UPF may include, for example, one or more of the following: measured jitter information per SDF; a relative time difference (delta) between an SDF and the primary SDF; an indication of which SDF the UPF may use as the primary SDF; an indication of the QoS flow to which these SDFs may be bound, which may be provided if the UPF has multiple QoS flows carrying XRM traffic flows; a relative time difference between QoS flows, which may be provided if the UPF has multiple QoS flows carrying XRM traffic flows; a respective DL periodicity for each SDF flow, which may apply if the UPF is requested to determine the periodicity; and/or an indication of the cause for sending the measurement report (e.g., a periodic report of delta values between SDF2 and SDF1, the jitter change of SDF1 exceeding a threshold, etc.). The UPF may provide the measurement report, for example, based on a configured reporting frequency and/or reporting thresholds.

At 4 of FIG. 9, the SMF may send DL periodicity information, jitter information, and/or delta information to a RAN node such as a base station. The SMF may send the information, for example, every time the SMF receives a measurement report from the UPF. The SMF (e.g., alternatively) may be configured with its own periodicity and/or thresholds for sending the DL periodicity information, jitter information, and/or delta information to the RAN. Such SMF configuration is not shown in FIG. 9.

The SMF may send the information to the RAN node as part of TSCAI or as part of a signaling exchange between the SMF and the RAN node. Information provided by the SMF to the RAN node may include, for example, one or more of the following: an SDF identifier, e.g., to identify the SDF; a QoS flow identifier, e.g., to identify the QoS flow to which the SDF is bound; a primary SDF, e.g., used for relative time difference calculations; a relative time difference (e.g., delta) between SDF and primary SDF; a measured jitter per SDF flow; and/or DL periodicity per SDF flow.

At 5 of FIG. 9, the RAN node may use the jitter information and/or the DL periodicity to configure CDRX for the WTRU. For example, the RAN node may use the information to determine the approximate arrival times of DL traffic over (e.g., all) the QoS flows to the WTRU. The RAN node may send the CDRX configuration information to the WTRU via an RRCReconfiguration message.

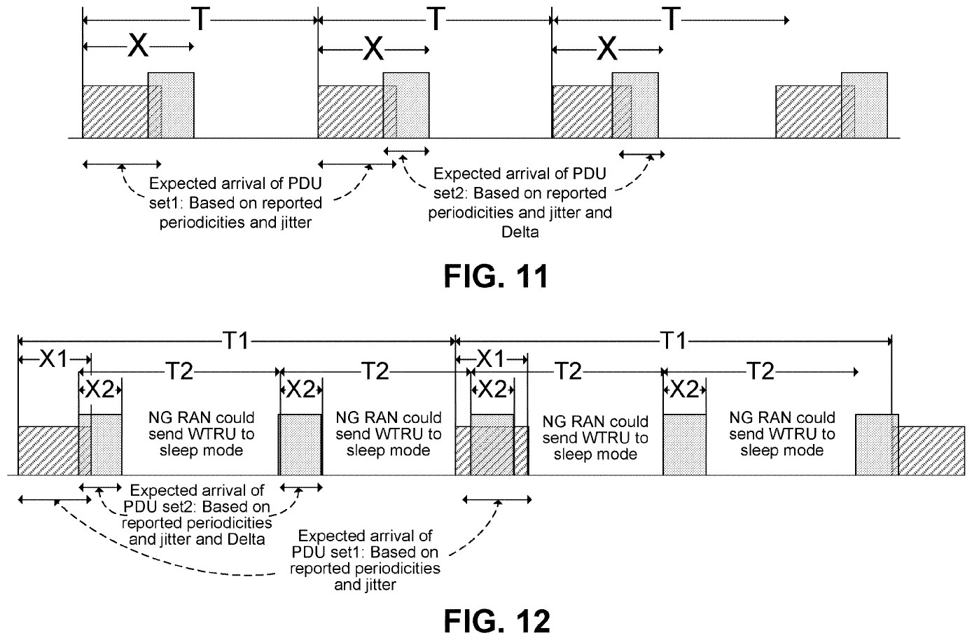

FIG. 11 shows an example where a WTRU has a QoS flow with two SDFs having the same DL periodicity, and a RAN node determines a DRX cycle with the same periodicity. As shown in FIG. 11, the RAN node may determine the expected arrival times of PDU sets at the RAN node, wherein the PDUs may be from SDF1 (PDU set1) and/or from SDF2 (PDU set2), The RAN node may make the determination, for example, based on the DL periodicity information, jitter information, and/or delta information from the SMF. The RAN node may determine how long the WTRU should be awake (e.g., X seconds within every T seconds). The RAN node may set the DRX cycle and/or DRX on/off durations according to the ratio of X to T, and may configure the WTRU accordingly.

FIG. 12 shows an example where a WTRU has a QoS flow with two SDFs having different DL periodicities, and a RAN node determines a DRX cycle with different periodicities. The RAN node may determine the expected arrival times of PDU sets at the RAN node, wherein the PDU sets may be from SDF1 (PDU set1) and SDF2 (PDU set2). The RAN node may make the determination, for example, based on the DL periodicity information, jitter information, and/or delta information from the SMF. Depending on the expected arrival time of PDU sets of each SDF, the RAN node may or may not be able to determine an efficient X and T that take into account the SDFs. The RAN node may (e.g., for this case) determine an X and T for each SDF (e.g., X1 and T1 for SDF1, and X2 and T2 for SDF2). The RAN node may configure the WTRU with two DRX cycles (e.g., a first DRX cycle for SDF1 and a second DRX cycle for SDF2). The WTRU may (e.g., in such a case) go to a power saving state when (e.g., only when) both DRX cycles are in an OFF state.

The example procedures described herein may assume that a primary SDF is defined for each QoS flow. In some (e.g., alternate) implementations, a single SDF may be used as the primary SDF for multiple (e.g., all) QoS flows. The UPF may, in those implementations, report the relative time difference of the SDFs in (e.g., all) QoS flows relative to this primary SDF. Further, signaling may be performed in those implementations to indicate the QoS flow to which the primary SDF is bound. Such signaling may be performed, for example, when signaling the primary SDF (e.g., from the UPF to the SMF, or from the SMF to the RAN node).

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A network device associated with a wireless communication network, wherein the network device comprises a processor that is configured to:
receive information regarding one or more aspects of jitter monitoring within the wireless communication network;
determine a jitter monitoring policy based on the received information;
send the jitter monitoring policy to another device in the wireless communication network; and
receive, after sending the jitter monitoring policy to the other device in the wireless communication network, an indication of a jitter measurement result from the other device.

2. The network device of claim 1, wherein the processor is configured to receive the information regarding the one or more aspects of jitter monitoring within the wireless communication network from a network exposure function (NEF) associated with an application server (AS) or an application function (AF).

3. The network device of claim 2, wherein the processor is further configured to transmit the indication of the jitter measurement result to the NEF.

4. The network device of claim 1, wherein the information regarding the one or more aspects of jitter monitoring within the wireless communication network indicates that jitter monitoring is to be performed at a protocol data unit (PDU) set level or a burst level.

5. The network device of claim 4, wherein the jitter monitoring policy is associated with a PDU session comprising extended reality traffic.

6. The network device of claim 1, wherein the information regarding the one or more aspects of jitter monitoring within the wireless communication network indicates a jitter measurement time period or a jitter sampling time period.

7. The network device of claim 1, wherein the information regarding the one or more aspects of jitter monitoring within the wireless communication network indicates a jitter monitoring trigger condition.

8. The network device of claim 1, wherein the processor is configured to determine and send the jitter monitoring policy as a quality of service monitoring rule.

9. The network device of claim 1, wherein the information is received via a policy authorization request, and wherein the processor is further configured to transmit a policy authorization response that confirms use of the information received via the policy authorization request.

10. The network device of claim 1, wherein the network device is a policy control function of the wireless communication network, and wherein the other device is a session management function of the wireless communication network.

11. A method implemented by a network device associated with a wireless communication network, the method comprising:
receiving information regarding one or more aspects of jitter monitoring within the wireless communication network;
determining a jitter monitoring policy based on the received information;
sending the jitter monitoring policy to another device in the wireless communication network; and
receiving, after sending the jitter monitoring policy to the other device in the wireless communication network, an indication of a jitter measurement result from the other device.

12. The method of claim 11, wherein the information regarding the one or more aspects of jitter monitoring within the wireless communication network is received a network exposure function (NEF) associated with an application server (AS) or an application function (AF).

13. The method of claim 12, further comprising transmitting the indication of the jitter measurement result to the NEF.

14. The method of claim 11, wherein the information regarding the one or more aspects of jitter monitoring within the wireless communication network indicates that jitter monitoring is to be performed at a protocol data unit (PDU) set level or a burst level.

15. The method of claim 14, wherein the jitter monitoring policy is associated with a PDU session comprising extended reality traffic.

16. The method of claim 11, wherein the information regarding the one or more aspects of jitter monitoring within the wireless communication network indicates a jitter measurement time period or a jitter sampling time period.

17. The method of claim 11, wherein the information regarding the one or more aspects of jitter monitoring within the wireless communication network indicates a jitter monitoring trigger condition.

18. The method of claim 11, wherein the jitter monitoring policy is determined and sent as a quality of service monitoring rule.

19. The method of claim 11, wherein the information regarding the one or more aspects of jitter monitoring within the wireless communication network is received via a policy authorization request, and wherein the method further comprises sending a policy authorization response that confirms use of the information received via the policy authorization request.

20. The method of claim 11, wherein the network device is a policy control function of the wireless communication network, and wherein the other device is a session management function of the wireless communication network.
